(19) United States
(12) Patent Application Publication
(10) Pub. No.: US 2006/0109455 A1
(43) Pub. Date: May 25, 2006

(54) Optical inspection system and radiation source for use therein

(75) Inventors: Marco Haverlag, Eindhoven (NL); Daniel Cornelis Schram, Eindhoven (NL); Richard Antonius Hendricus Engeln, Utrecht (NL); Adrianus Henricus Johannes Van Den Brandt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,231

(22) PCT Filed: Nov. 26, 2003
(86) PCT No.: PCT/IB03/05857

§ 371 Date: May 24, 2005

(30) Foreign Application Priority Data
Nov. 28, 2002 (EP) 02080004.1

(51) Int. Cl. G01N 21/88

(52) U.S. Cl. 356/237.2

(57) ABSTRACT

Disclosed is a system for inspecting an object. Such system comprises; a) an irradiation system for irradiating the object to be inspected, said irradiation system comprising a radiation source, b) an objective, imaging the irradiated object onto an image sensor, and c) an image sensor for transforming the radiation coming from the object to be inspected into a detectable signal. The radiation source comprises; A) at least one cathode, B) at least one anode, C) one or more plates, positioned in between said cathode(s) and said anode(s), and being electrically substantially insulated, wherein each plate comprises at least one hole, aligned in such a way that a continuous path is created between cathode and anode over which a discharge can extend.

The present invention relates to a system for inspecting an object, comprising:

an irradiation system for irradiating the object to be inspected, said irradiation system comprising a radiation source,

an objective, imaging the irradiated object onto an image sensor, and
an image sensor for transforming the radiation coming from the object to be inspected into a detectable signal.

In the above inspection system, the radiation that comes from the object to be inspected generally contains information on patterns that are present in or on the object, thicknesses of layers on the object and/or compositions of materials on the object.

Optical inspection systems are widely used for inspecting objects. For example, in the semiconductor industry use is made of—automatic—wafer inspection systems. Such wafer inspection systems are used for the inspection of the quality of wafer processing in order to detect processing defects, layer thicknesses and/or contamination on the wafers.

During the processing of a wafer an array of patterns is placed on the wafer and each pattern has to be placed with submicron precision, as line widths and elemental areas are very small. Successive layers are to be built up for each pattern on a wafer and these have to be carefully checked before any further processing can be undertaken. Optical inspection is used to determine whether any defects have been introduced, such as for example misalignment, electrical shortcuts, and impurities.

Currently, in wafer inspection systems, broadband radiation from high power Hg/Xe arc lamps is used. These Hg/Xe arc lamps yield radiation in the range of 200-700 nm, of which predominantly the shorter wavelengths are used.

However, the semiconductor industry constantly reduces the feature sizes on the wafers. Line widths of 80-90 nm are applied at present, while not long ago the minimum line width was 200 nm. This line width reduction requires the use of a radiation source with smaller wavelengths in the wafer inspection system in order to be able to see the smaller details.

Next to that, in order to operate the wafer inspection systems effectively, there is a minimum required in the radiation flux on the inspected products to reach the required inspection speed (in wafers/hour).

With the current Hg/Xe arc sources the options both to provide for shorter wavelengths and to increase the radiant flux on the inspected products are limited due to the absence of emitted radiation at shorter wavelengths as well as the limited radiance at larger wavelengths.

The present invention aims to provide for a solution to the above problem. To that end, the present invention provides for an inspection system according to the preamble that is characterized in that the radiation source comprises:

at least one cathode

at least one anode

one or more plates, positioned in between said cathode(s) and said anode(s), and being electrically substantially insulated, wherein each plate comprises at least one hole, aligned in such a way that a continuous path is created between cathode and anode over which a discharge can extend.

In the above system, the plates are in particular placed in a cascade and are electrically substantially insulated from each other, from the cathode(s) and from the anode(s).

The arrangement of the radiation source is also referred to as a cascade arc radiation source. A cascade arc source is, for example, disclosed in U.S. Pat. No. 4,871,580, which is incorporated herein by reference. A cascade arc comprises three major sections; a cathode section, an anode section and a plate section in-between. The plate section, which typically comprises several plates with holes stacked into a cascade, gives the arc its name. Upon operation, an electrical current is flowing from the anode to the cathode, through the holes in the cascade plates, creating plasma that generates light.

A cascade arc source provides for a radiance that is much higher than the radiance of the common Hg/Xe arc sources. The cascade arc source emits its flux in a very small geometrical extent and has a radiance of approximately 0.1 W/nm/mm²/sr There are two main benefits of this source with respect to the currently used high power Hg/Xe arc lamps. First of all, the source emits light at shorter wavelengths, allowing a higher spatial resolution. The cascade arc source emits radiation in a wavelength range from below 125 nm to the infrared. A range of 120-400 nm, or when preferred, in view of absorption in quartz below 190 mn, 190-400, can easily be reached. Moreover, the source has a small geometrical extent enabling much larger magnifications of the object to be inspected, even at very high speed.

Preferably, the inspection system according to the invention provides for a wavelength region that is limited to any band or set of bands of wavelengths, comprising at least radiation at wavelengths of at least 190 nm.

Radiation at these shorter wavelengths from 190 nm is for example very favorable when the inspection system is used for inspecting semiconductor devices.

Advantageously, the radiation source produces radiation with radiance larger than 10 mW/nm/mm²/steradian.

Although in principle all kind of objects could be inspected by the system according to the present invention, the system is in particular suitable for inspecting bare, partially or fully processed semiconductor wafers or reticles or masks used in a lithographic process to produce a patterned layer on a semiconductor wafer.

Preferably, the irradiation system comprises optical means for homogenizing the spatial distribution of the irradiation in the image plane on the object. In particular, the optical means comprise a homogenizer.

Such homogenizer conditions the light coming from the radiation source and homogenizes the spatial distribution thereof.

The present invention also relates to a radiation source as disclosed in the above for use in an optical inspection system.

The present invention will be illustrated with reference to the drawing, in which:

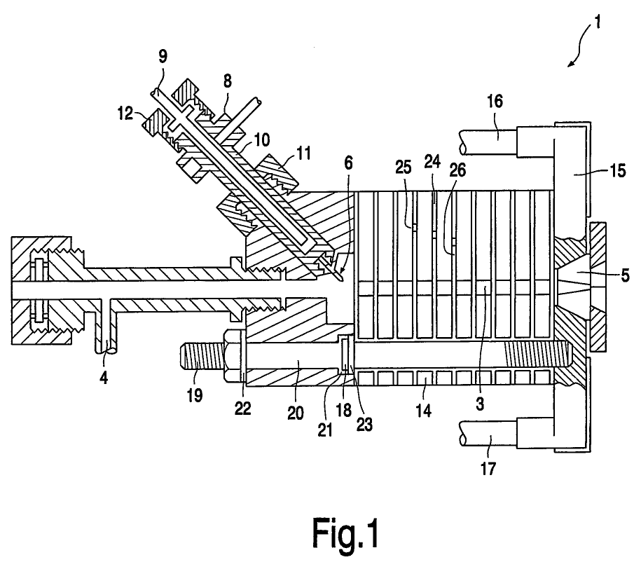

FIG. 1 schematically shows a cascade arc source; and

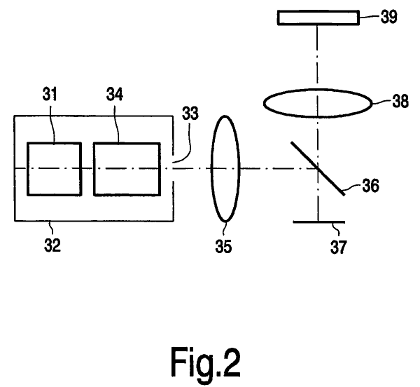

FIG. 2 schematically shows an optical design for wafer inspection according to the invention.

The figures are purely schematic and not drawn to scale. Similar elements will be referred to with the same reference numerals as far as possible.

FIG. 1 shows a cascade arc radiation source 1. Said cascade arc comprises three major sections; a cathode section, an anode section and a plate section in-between. The plate section, which comprises several plates stacked into a cascade, gives the arc its name.

The exemplary construction of a cascade arc as shown in FIG. 1, comprises a central channel 3 having a length varying from 20-200 mm and a diameter varying from 0.5-10 mm.

Reference numeral 6 indicates a cathode tip. In FIG. 1 only one cathode tip is shown. In practice the amount of cathodes is variable, but preferably at least three cathode tips will be present. Advantageously, the cathode tips comprise an alloy of thorium in tungsten. The cathode tips are preferably arranged rotatively around the central channel 3 and are mounted in hollow holders 8 through which cooling water is fed via duct 9. The holders 8 are at least partially enclosed in an electrically insulating sleeve 10, for example made from quartz, and are held in position by a screw 11 which accommodates a rubber ring—not shown in FIG. 1—and which clamps the holder 8 vacuum tight. The duct 9 is clamped tight in the holder 8 by a screw 12.

The cathode tips 6 can easily be replaced by removing the holder 8 from the arc assembly, replacing the cathode tip 6 and putting the holder with the new tip back in the assembly.

Reference numeral 4 indicates an inlet through which a flushing gas can be fed. As examples of such flushing gas noble gases like argon and xenon can be mentioned. Reference numeral 5 indicates a nozzle-like anode that is located at the end of channel 3 opposite the cathodes 6. In the embodiment shown, the anode 5 comprises an easily removable conical insert that is placed into a conical hole in a water-cooled plate 15. Cooling water is fed to this cooling-plate 15 via inlet 16 and discharged therefrom via the outlet 17.

A stack of cascade plates 14 are affixed to the anode plate 15 by a bolt 18 and a nut 19. Electrical insulation is achieved by the presence of sleeve 20, cap 21, and rings 22 and 23. The cascade plates 14 are for example made of copper. Due to the high temperatures in the cascade arc—up to over 16,500 K—the plates must be cooled. The cooling liquid channels, which are not shown in FIG. 1, are close to the central channel 3, resulting in good heat dissipation. The cascade plates 14 are separated from one another and electrically insulated by means of a sealing system of “O” rings 24, spacers 25 (e.g. PVC spacers), and central rings 26 made of boron-nitride. The seals ensure that the arc can be maintained at pressures between 0.05 and 20 bar. The central rings are white colored and reflect the light radiating from the plasma. The object of the central rings is to act as protection for the “O” rings against melting under the influence of plasma light absorption.

During operation of the cascade arc a direct-current electricity of between 20-200 A can flow from the nozzle like anode 5 to the cathode tips 6. Operation of the cascade arc using pulsed electrical currents is also possible.

The arc can be ignited by first lowering the gas pressure to approximately 10 mbar and applying a voltage difference of approximately 1000 V between the anode and the cathode (voltage depending on, amongst others, electrode-distance). Once the arc is ignited, the pressure of the gas is increased to operating pressure, i.e. between 0.05-20 bars. Other ignition procedures are also conceivable.

FIG. 2 represents schematically an example of an optical design of a wafer inspection system according to the invention. It will be clear that within the scope of the invention many other designs are possible. Reference numeral 32 refers to an illumination system. In the present example, said system comprises a cascade arc 31 that is used as a light source. Furthermore, the illumination system 32 comprises means 34 for spatially homogenizing the beam intensity at the exit 33 of the illumination system 32.

The light beam that leaves the illumination system through exit 33 passes collimator lens system 35. Numeral 38 refers to the objective of the inspection system. Reference numeral 39 indicates an image sensor. The objective both images the light beam onto the wafer 37 and collects the reflected light from the wafer. With a beam splitter 36 the light is directed out of the illumination path and together with the objective an image of the wafer is made.

Although the present invention is illustrated by means of the above examples, it is not intended that the invention is limited to these examples. On the contrary, many variations are possible within the scope of the present invention.

1. System for inspecting an object, comprising:
an irradiation system for irradiating the object to be inspected, said irradiation system comprising a radiation source,
an objective, imaging the irradiated object onto an image sensor, and
an image sensor for transforming the radiation coming from the object to be inspected into a detectable signal, characterized in that the radiation source comprises:
at least one cathode
at least one anode
one or more plates, positioned in between said cathode(s) and said anode(s), and being electrically substantially insulated, wherein each plate comprises at least one hole, aligned in such a way that a continuous path is created between cathode and anode over which a discharge can extend.

2. Inspection system according to claim 1, characterized in that the wavelength region is limited to any band or set of bands of wavelengths, comprising at least radiation at wavelengths of at least 190 nm.

3. Inspection system according to claim 1, characterized in that the radiation source produces radiation with a radiance larger than 10 mW/nm/mm²/steradian.

4. Inspection system according to claim 1, characterized in that the irradiated object is a bare, partially or fully processed semiconductor wafer.

5. Inspection system according to claim 1, characterized in that the irradiated object is a reticle or mask used in a lithographic process to produce a patterned layer on a semiconductor wafer.

6. Inspection system according to claim 1, where the irradiation system comprises optical means for homogenizing the spatial distribution of the irradiation.

7. Inspection system according to claim 6, characterized in that the optical means comprise a homogenizer.

8. Radiation source as disclosed in claim 1 for use in an optical inspection system.
